(19) United States
(12) Patent Application Publication
(10) Pub. No.: US 2022/0355386 A1
(43) Pub. Date: Nov. 10, 2022

(54) PIPE CUTTING APPARATUS HAVING A HAND GUARD

(71) Applicant: Team Industrial Services, Inc., Sugar Land, TX (US)

(72) Inventors: Jimi WADE, Umbria (GB); Mark King, Cumbria (GB)

(21) Appl. No.: 17/763,119

(22) PCT Filed: Sep. 25, 2020
(86) PCT No.: PCT/US2020/052693

§ 371 Date: Mar. 23, 2022

Related U.S. Application Data
(60) Provisional application No. 62/906,937, filed on Sep. 27, 2019.

(51) Int. Cl. B23B 3/26; B23B 25/04

(52) U.S. Cl. CPC B23B 3/26; B23B 25/04

(57) ABSTRACT

A pipe cutting apparatus having a hand guard is described. The hand guard comprises a body, the body including: a top surface having a curved shape; a bottom surface having a curved shape, wherein the top surface and the bottom surface form an extended end having a wedge shape; an engagement surface having a curved shape and extending from the bottom surface, and an attachment portion. The body also comprises a first recess having a curved shape, wherein the first recess is disposed between the attachment portion and the extended end. The hand guard can prevent an operator's hand from being caught in a pinch area between a pipe cutting tool and the housing.

### PRIOR RELATED APPLICATIONS

This application claims priority to U.S. Provisional Application No. 62/906,937, filed on Sep. 27, 2019, which is incorporated herein for all purposes.

### FIELD OF DISCLOSURE

In general, the disclosure describes a pipe cutting apparatus that may be mounted on the outer diameter of a pipe and a hand guard for providing hand protection to an operator. The pipe cutting apparatus has a tool carrier rotatably mounted on a frame with a motor mounted on the frame to rotate the tool carrier and the hand guard for guarding hands from a pinch area.

### BACKGROUND OF DISCLOSURE

A pipe cutting apparatus may be mounted on the outer diameter of a pipe, sometimes referred to as a tubular. The pipe cutting apparatus may have a split frame assembly having a frame and a tool carrier rotatably coupled to the frame. The tool carrier may have at least one tool support configured to support a tool that may be used to cut the pipe as the tool carrier rotates. A motor is attached to the frame and the motor is configured to rotate the tool carrier with respect to the stationary frame, motor and pipe. During operation of the pipe cutting apparatus, a rotation pinch area between the motor and the tool support may occur as the tool support approaches and passes by the motor attached on the frame of the split frame assembly.

An improved pipe cutting apparatus is needed to allow for better site access and for installation and operation on a pipe in workspaces that may have limited space.

### SUMMARY

This summary is provided to introduce a selection of concepts that are further described below in the detailed description. However, many modifications are possible without materially departing from the teachings of this disclosure. Accordingly, such modifications are intended to be included within the scope of this disclosure as defined in the claims. This summary is not intended to identify key or essential features of the claimed subject matter, nor is it intended to be used as an aid in limiting the scope of the claimed subject matter.

An embodiment of the present disclosure provides a pipe cutting apparatus including a frame having a circumferential frame surface; a tool carrier rotatably coupled to the frame; a tool support coupled to and rotatable with the tool carrier; a housing coupled to the frame and extending radially outward from the circumferential frame surface, wherein the housing has an outer housing surface; and a hand guard disposed on the circumferential frame surface, wherein the hand guard comprises: a body, the body including: a top surface having a curved shape, a bottom surface having a concave shape and disposed adjacent to the circumferential frame surface, wherein the top surface and the bottom surface form an extended end having a wedge shape, an engagement surface having a concave shape and disposed adjacent to the outer housing surface, an attachment portion; and a first recess formed by the engagement surface and configured to fit on the housing, wherein the first recess is disposed between the attachment portion and the extended end.

Another embodiment of the present disclosure provides a hand guard configured to be coupled to a pipe cutting apparatus having a circumferential frame and surface housing, the hand guard comprising: a body, the body including: a top surface having a curved shape, a bottom surface having a curved shape, wherein the top surface and the bottom surface form an extended end having a wedge shape, an engagement surface having a curved shape and extending from the bottom surface, an attachment portion, a first recess having a curved shape, wherein the first recess is disposed between the attachment portion and the extended end.

In one embodiment, the hand guard is reversibly mounted on the circumferential frame surface, such that a different hand guard may be replaced if it is damaged or otherwise needs changing.

In one embodiment, the attachment portion is an attachment plate that is reversibly mounted on the circumferential frame surface of the frame. As will be further described below, different hand guard configuration may be desirable depending on the operation and operator's preference.

In one embodiment, the housing has a center and an axis radially passing through the center to divide the housing and the hand guard into a first side and a second side, wherein the extended end of the hand guard is on the first side, and wherein the attachment portion is an attachment leg that abuts the circumferential frame surface on the second side.

### BRIEF DESCRIPTION OF THE FIGURES

Certain embodiments of the disclosure will hereafter be described with reference to the accompanying drawings, wherein like reference numerals denote like elements. It is emphasized that, in accordance with standard practice in the industry, various features are not drawn to scale. In fact, the dimensions of various features may be arbitrarily increased or reduced for clarity of discussion. It should be understood, however, that the accompanying figures illustrate the various implementations described herein and are not meant to limit the scope of various technologies described herein, and:

FIG. 1A is a front perspective view of a pipe cutting apparatus mounted on an outer diameter of a pipe and having a hand guard in accordance with embodiments of the present disclosure;

FIG. 1B is a blow up of the portion of lA near the housing.

FIG. 2A is a back perspective view of the pipe cutting apparatus and the hand guard of FIG. 1.

FIG. 2B-D are front perspective views of the pipe cutting apparatus and the hand guard showing the pinch area and the rotation of the tool.

FIG. 3 is a front perspective view of the pipe cutting apparatus mounted on the outer diameter of the pipe and having another embodiment of the hand guard of the present disclosure.

FIG. 4 is a front perspective view of the pipe cutting apparatus mounted on the outer diameter of the pipe and having another embodiment of the hand guard of the present disclosure;

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements.

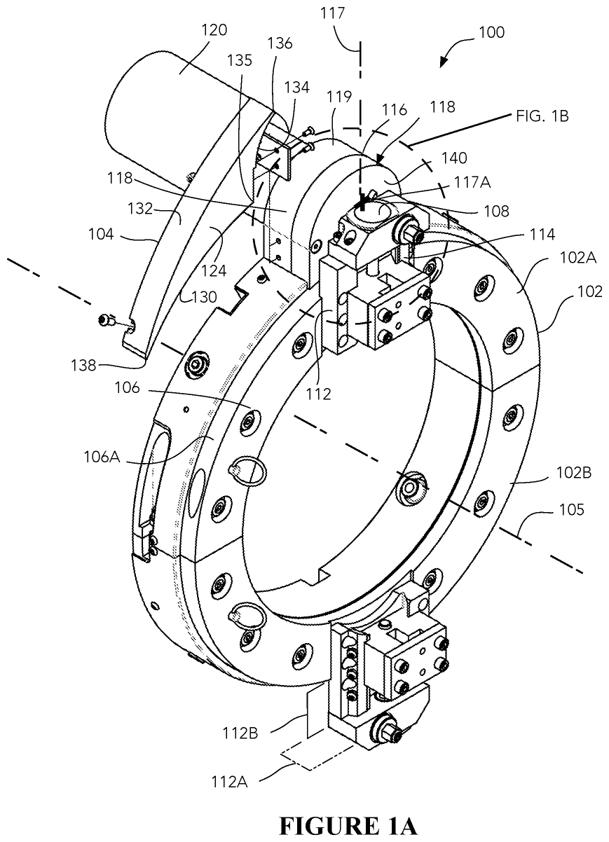

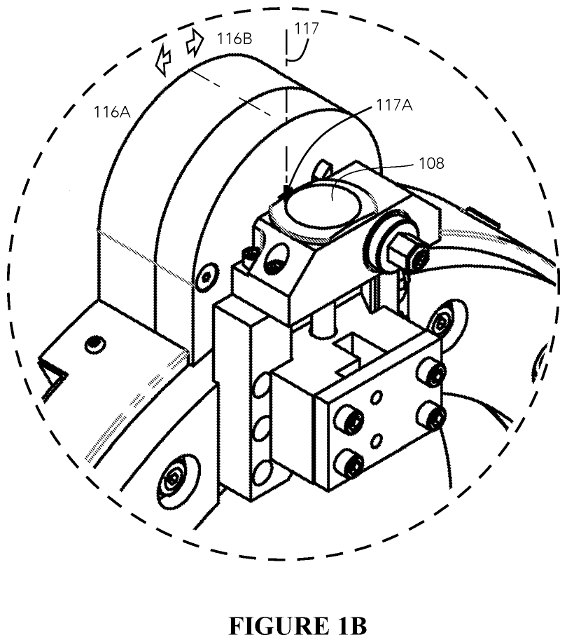

Referring to FIGS. 1A-B and 2, an embodiment of a pipe cutting apparatus, referenced generally as 100, of the present disclosure is shown. Pipe cutting apparatus 100 is configured to cut and machine pipes 10 of different diameters, including cutting completely through the pipe 10 and beveling the pipe 10. Pipe cutting apparatus 100 includes a split frame assembly 102 and a hand guard 104. Split frame assembly 102 is formed by a first frame assembly section 102A and a second frame assembly section 102B. Frame assembly sections 102A, 102B may each have a semi-circular shape and may be unattached from one another when in a disassembled position. Frame assembly sections 102A, 102B may be assembled to join the frame assembly sections 102A, 102B together on the pipe 10 to form the split frame assembly 102. Split frame assembly 102 is shown in FIG. 1 in a mounted position on the pipe 10. A longitudinal axis 105 extends through a center of the split frame assembly 102 and the pipe 10.

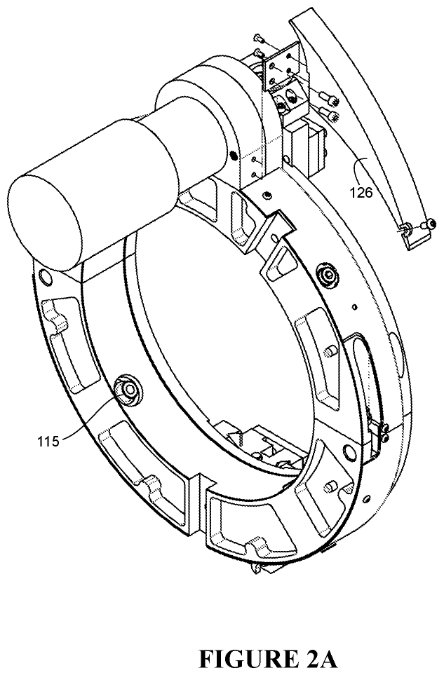

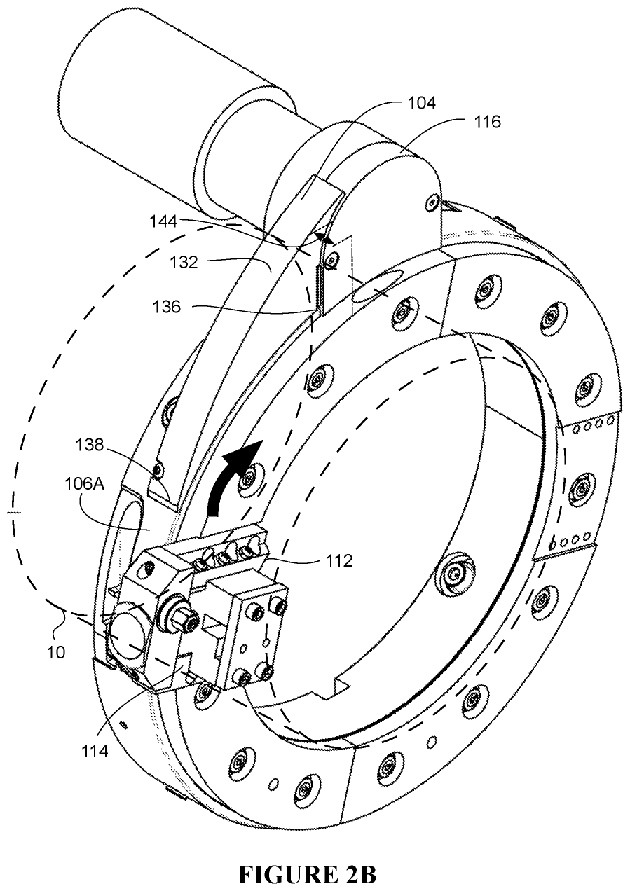

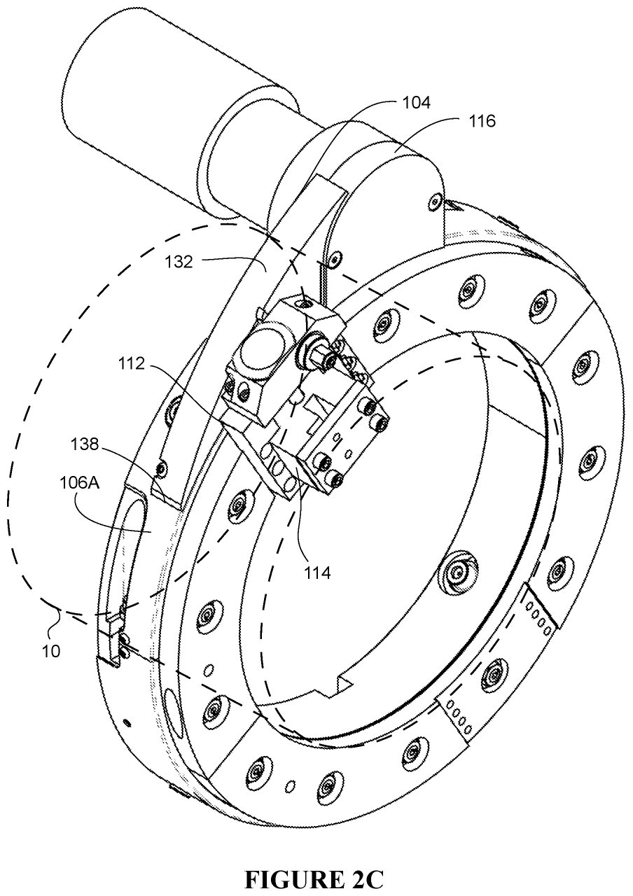

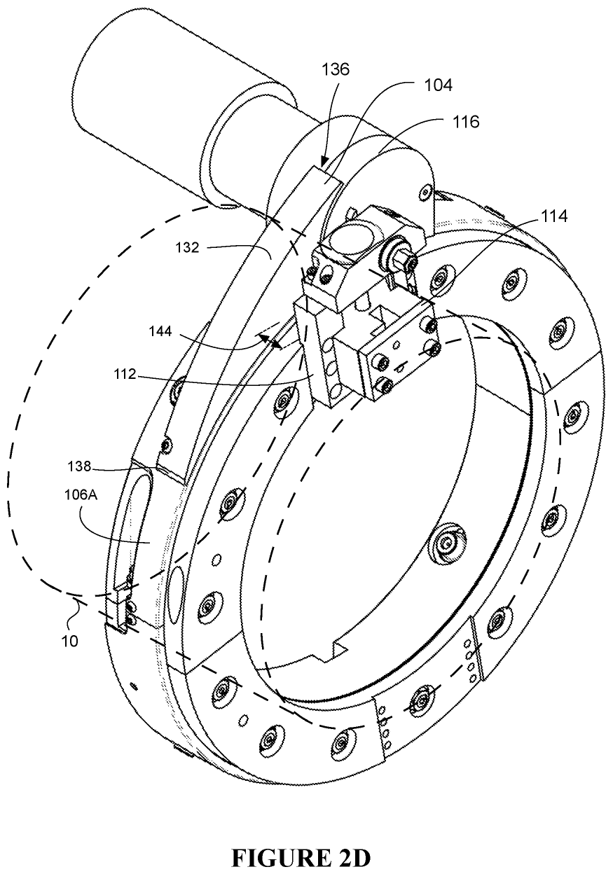

Split frame assembly 102 includes a frame 106 and a tool carrier 108. As shown in FIG. 1, frame 106 is mounted on the outer diameter of the pipe 10 in a fixed position and has a ring shape that extends around the circumference of the pipe 10. Split frame assembly 102 may have spaced-apart, clamp members or coupling members 115 attached to the frame 106 and that may be engaged with the pipe 10. FIG. 2 shows one of the coupling members 115. Clamp members 115 are adjustable to couple and concentrically locate the split frame assembly to the pipe 10.

Tool carrier 108 is rotatably mounted on the frame 106 and has a ring shape extending around the circumference of the pipe 10. Longitudinal axis 105 extends longitudinally through the center of the frame 106 and the tool carrier 108. Tool carrier 108 is rotatably coupled to the frame 106 configured to rotate with respect to the frame 106 and the pipe 10. The rotatable tool carrier 108 includes two tool supports 112 that each may support a cutting tool 114 for performing cutting or machining operations on the pipe 10 as the tool carrier 108, tool supports 112, and the supported cutting tools 114 rotate circumferentially around the pipe 10. Tool supports 112 may be referred to as tool slides, and one or multiple additional tool supports 112 may be bolted on the tool carrier 108. As shown in FIG. 1, tool support 112 has a tool support overhang section 112A that extends radially, also referred to as outwardly, from a circumferential frame surface 106A of the frame 106. Tool support 112 has a tool support top section 112B that is radially extended from the circumferential frame surface 106A.

Split frame assembly 102 further includes a housing 116 disposed above the circumferential frame surface 106A. Housing 116 may be coupled to the frame 106 and is attached to the frame 106 in the embodiment shown in FIG. 2. Housing 116 is configured to be coupled to a motor 120 and is positioned adjacent to the housing 116, as shown in FIG. 5 and FIG. 6. Motor 120 may be a pneumatic motor, hydraulic motor, or an electric motor. Motor 120 is configured to rotate the tool carrier 108 relative to the frame 106. Housing 116 may contain drive components 121, including a pinion gear, configured to be driven by the motor 120 to rotate the tool carrier 108 relative to the frame 106. In the embodiments shown in FIGS. 1-4, the housing 116 has a curved outer housing surface 118. Housing 116 has a housing axis 117 extending through a housing center 117A and through top housing section 119. A first housing side 116A and a second housing side 116B of the housing 116 are on opposite sides of the housing axis 117. In the embodiment shown in FIGS. 1A-B, the housing portions 116A, 116B each form a half of the housing 116. Housing 116 may have a cylindrical, U-shape, or another shape for enclosing components for coupling the motor 116 to the tool carrier 108.

Hand guard 104 extends radially from the circumferential frame surface 106A and is positioned adjacent to a curved, outer housing surface 118 of the housing 116, see FIG. 2. Hand guard 104 may be made of plastic or another material that may be selected for durability and low weight. Hand guard 104 has a body with a front face 124, shown in FIG. 1, and an opposing back face 126, shown in FIG. 2. Faces 124, 126 may be flat and parallel to one another. Hand guard 104 has a bottom surface 130, a top surface 132, and an engagement surface 134. Engagement surface 134 connects with the bottom surface 130 at a first end 135 and connects with the top surface 132 at a second end 136. Bottom surface 130 extends from the first end 135 to an extended end 138. Top surface 132 extends from the second end 136 to the extended end 138. Extended end 138 is the end section of the hand guard 104 spaced away from the housing 116. Surfaces 130, 132, 134 have a curved shape and define the outer periphery of the faces 124, 126.

Referring also to FIG. 1B, hand guard 104 is positioned adjacent to and abuts against the curved, outer housing surface 118. Engagement surface 134 extends upwardly from the circumferential frame surface 106A and along the outer housing surface 118 of the first housing side 116A. Engagement surface 134 ends before the housing axis 117 in the embodiment shown in FIGS. 1-4. In alternate embodiments, engagement surface 134 may extend to the housing axis 117 or past the housing axis 117. Engagement surface 134 has a shape that corresponds with the outer housing surface 118. Engagement surface 134 abuts against the outer housing surface 118. Motor 120 and the hand guard 104 form a side-by-side blocking structure that extends upwardly along a portion of the circumferential frame surface 106A, see FIG. 1 and FIG. 2.

Bottom surface 130 of hand guard 104 is positioned adjacent to and abuts against a portion of the circumferential frame surface 106A. Bottom surface 130 has a curved shape that corresponds with the curved shape of the circumferential frame surface 106A. Bottom surface 130 abuts against the circumferential frame surface 106A. Bottom surface 130 corresponds to the shape of the curved surface of the adjacent frame 106 to form a blocking structure extending upwards from the circumferential frame surface 106A.

Top surface 132 of the hand guard 104 is a curved surface that tapers downwardly from the second end 136 to the extended end 138. In the embodiment of the hand guard 104 shown in FIGS. 1-4, the hand guard 104 has a curved wedge shape at each of the second end 137 and the extended end 138. The top surface 132 and the bottom surface 130 form an acute angle at the extended end 138. Top surface 132 and engagement surface 134 form an acute angle at the second end 136. As shown in FIGS. 1-4, the second end 136 of the hand guard 104 terminates on the outer housing surface 118 before it reaches a top housing section 119 of the housing 116. Housing axis 117 intersects top housing section 119. Top surface 132 of the hand guard 104 and the outer housing surface 118 together form a continuous top blocking surface that tapers upwardly and extends from the extended end 138 to the top housing section 119, as shown in FIGS. 1-4.

As shown in FIG. 1, a face cover 140 may be attached to the housing 116 to attach the hand guard 104 in a blocking guard position. Face cover 140 may be secured to the housing 116 with adhesives and/or mechanical fasteners such as brackets, screws, or other standard fasteners.

In operation, referring to FIGS. 1A and 2B, the pipe cutting apparatus 100 may be operated to cut the pipe 10. Split frame assembly 102 is mounted on the outer diameter (OD) of the pipe 10 in the mounted position. Cutting tools 114 are positioned in the tool supports 112 for cutting, beveling, or other machining operation. Motor 120 is turned on to rotate the tool carrier 108. An arrow 142 represents clockwise rotation of the tool carrier 108 relative to the frame 106 and the pipe 10 being cut. An arrow 144 (FIG. 2B-2C) shows a housing pinch area between tool support 112 and the housing 116 that is being protected by the hand guard 104.

Hand guard 104 helps reduce the risk of a pinch injury to an operator in the housing pinch area. Hand guard 104 forms a blocking shield above a portion of the circumferential frame surface 106A. More specifically, the hand guard 104 forms a shield to help block an operator standing at the side or rear of the pipe cutting apparatus 100 from reaching into the housing pinch area between the housing 116 and the clockwise rotating tool support 112. If an operator's hand does engage the rotating tool support 112, the curved top surface 132 of the hand guard 104 tapers upwardly between the extended end 138 and the first end 136 to help guide the operator's hand upwardly away from the rotating tool support 112 and the housing pinch area. In this way, the operator's hand will not fall in any depth in the housing pinch area between the tool support 112 and the housing 116.

Referring to FIG. 2B, the tool support 112 is shown in a first rotational position where the tool support 112 is positioned adjacent to the extended end 138 of the hand guard 104. The wedge-shape of the extended end 138 of the hand guard 104 helps reduce the risk of the hand guard 104 forming another pinch area between the rotating tool support 112 and the hand guard 104.

Also referring to FIG. 2C, the tool support 112 is shown in a second rotational position where the tool support 112 has rotated clockwise from the first rotational position closer to the housing 116. Tool support 112 is disposed adjacent to the front face 124 of the hand guard 104 as the tool support 112 rotates relative to the stationary hand guard 104. Tool support top section 112B extends above the top surface 132 of the hand guard 104 when the tool support 112 is in the first rotational position, shown in FIG. 2B, and the second rotational position, shown in FIG. 2C. In some embodiments, the tool support top section 112B will extend below the top surface 132 of the hand guard 104 when the tool support 112 is in a third rotational position where the tool support 112 is disposed adjacent and below the second end 136 of the hand guard 104, as shown in FIG. 2D.

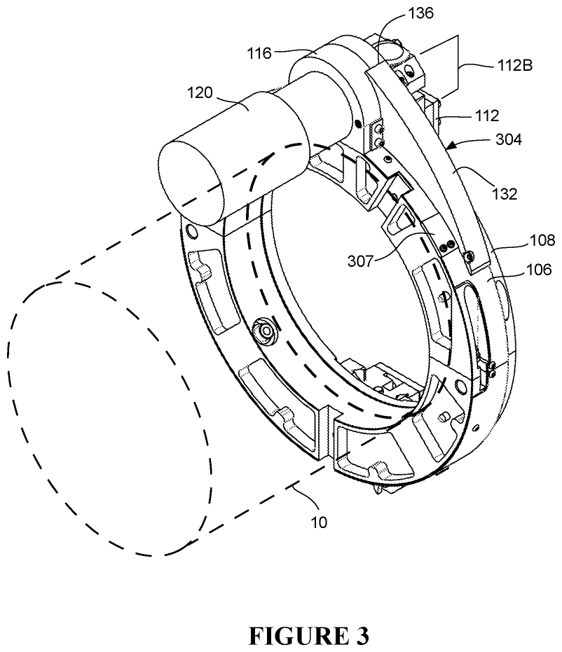

Referring to FIG. 3, another embodiment of a hand guard is shown, referenced as hand guard 304, installed on the pipe cutting apparatus 100 in the blocking guard position. Like parts are referenced with like reference numbers for alternative embodiments. As shown in FIG. 3, the tool support 112 attached to the tool carrier 108 is in third rotational position where the tool support 112 is disposed below the housing 116 and the second end 136 of the hand guard 304. In the embodiment shown in FIG. 3, the second end 136 of the hand guard 304 is disposed radially above the tool support top section 112B as the tool support top section 112B rotates past the second end 136. In other embodiments, the second end 136 may be disposed below the tool support top section 112B as the tool support top section 112B rotates past the second end 136. Hand guard 304 may include an attachment member 307 used to attach the hand guard 304 to the frame 106. Attachment member 307 may be in the shape of a curved plate, as shown in FIG. 3, and may be attached to the frame 106, for example with mechanical fasteners and/or adhesives, but other ways of securing the attachment member 307 to the frame 106 can also be used. Hand guard 304 may be secured to the attachment member 307, for example with mechanical fasteners and/or adhesives, or the attachment member 307 can be an integral part of the hand guard 304. Hand guard 304 may include a portion of the bottom surface 130 that abuts the frame 106 and another portion of the hand guard 304 that abuts the attachment member 307. Bottom surface 130 may have an inset section (not shown) that abuts the attachment member 307.

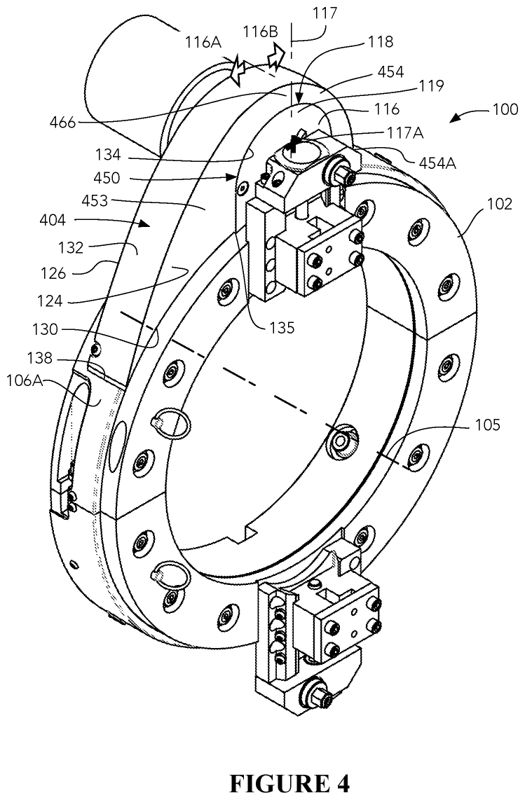

Referring to FIG. 4, an embodiment of a hand guard is shown, referenced as hand guard 404. FIG. 4 shows an embodiment of the hand guard 404 installed on the pipe cutting apparatus 100 in the blocking guard position. Like parts are referenced with like reference numbers for different embodiments of the hand guards of the present disclosure. Hand guard 404 has a body with a front face 124 and a back face 126 opposing the front face 124. Faces 124, 126 may be flat and parallel to one another. A first recess is formed in the body of the hand guard 404 and is configured to be positioned adjacent to a curved, outer housing surface of the housing 116. The body of the hand guard 404 has an attachment leg 454. Front face 124 and the back face 126 are disposed between the bottom surface 130, the top surface 132, and the engagement surface 134. Surfaces 130, 132, 134 are curved.

Bottom surface 130 of the hand guard 404 is disposed adjacent to the circumferential frame surface 106A when in the blocking guard position shown in FIG. 7. Bottom surface 130 has a recess opening that opens to the first recess 450. Engagement surface 134 forms the periphery of the first recess and extends from the bottom surface 130 at the first end 135 to a bottom leg end 454A. Engagement surface 134 has a shape configured to fit on the outer housing surface 118 when in the shielding guard position. Engagement surface 134 has a U-shape in FIG. 4. Axis 117 is shown extending through a center 117A of the first recess 450. Axis 117 may also extend through the center of the guard top, housing 116 and the longitudinal axis 105 of the pipe (not shown). Top surface 132 extends from the extended end 138 to the bottom leg end 454A.

Attachment leg 454 abuts the circumferential frame surface 106A at a bottom leg surface (not shown). Bottom leg surface may form a portion of the bottom surface 130. Bottom leg surface has a length that is less than the length of the bottom surface 130 extending between the extended end 138 and the first end 135. Attachment leg 454 may be used to help secure the hand guard 404 in the blocking guard position by sliding the housing 116 into the first recess 450, as shown in FIG. 4. In some embodiments, attachment leg 454 also includes a tapped hole for a set screw to allow for adjustment and locking of the attachment leg 454 to the frame 106.

Bottom leg end 454A may extend a first distance from one side of the housing 116 and the extended end 138 of the hand guard 404 may extend a second distance from the other side of the housing 116. The second distance is greater than the first distance in the embodiment shown in FIGS. 4 so that the extended end 138 extends circumferentially further from the housing 116 than the attachment leg 454.

First recess 450 is configured to allow the hand guard 404 to be easily installed on the housing 116, and placed in the blocking guard position, as shown in FIG. 4. Hand guard 404 is slid onto the housing 116 by moving the hand guard 404 downwards to slide housing 116 through the bottom recess opening and into the first recess 450. Engagement surface 134 defining the first recess is adjacent to and engages the outer housing surface 118 of both the first housing side 116A and the second housing side 116B. Attachment leg 754 extends from the circumferential frame surface 106A adjacent the second housing side 116B to the top housing section 119. The body of the hand guard 404 extends from the circumferential frame surface 106A adjacent the first housing side 116A to the top housing section 119. In some embodiments, first recess 450 allows the hand guard 404 to be attached to the split frame assembly 102 in the blocking guard position without the use of tools. The weight of the hand guard 404 is reduced by having the first recess 450 and having a curved top surface 132 that tapers upwardly from the extended end 138 to a guard top disposed above the top housing section 119.

The body of the hand guard 404 may be formed by a shield section 453 and the attachment leg 454, as shown in FIG. 4. Attachment leg 454 extends from one side of the axis 117 downward to the bottom leg surface and a main body section of the hand guard 404 extends from the opposite side of the axis 117 to the extended end 138.

As described herein, the pipe cutting apparatus of this disclosure provides a safe and efficient way of cutting pipes while preventing an operator's hand from being caught in a pinch area between the housing and the cutting tool. The use of a hand guard effectively moves the operator's hand away from the pinch area by creating a physical barrier near the housing, such that the operator's hand is kept at a distance from the pinch area.

Further, the size, shape and material of the hand guard is configured to add minimal weight to the pipe cutting apparatus, making it easy for an operator to move the apparatus where it is needed.

Although a few embodiments of the disclosure have been described in detail above, those of ordinary skill in the art will readily appreciate that many modifications are possible without materially departing from the teachings of this disclosure. For example, the pipe isolation device of the present disclosure may be modified by adding additional sealing heads to become a triple, or more, block and bleed apparatus. Accordingly, such modifications are intended to be included within the scope of this disclosure as defined in the claims. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. A pipe cutting apparatus, comprising:
a) a generally circular frame having a circumferential frame surface;
b) a tool carrier rotatably coupled to the frame;
c) a tool support coupled to and rotatable with the tool carrier;
d) a housing coupled to the frame and extending radially outward from the circumferential frame surface, wherein the housing has an outer housing surface; and
e) a hand guard disposed on the circumferential frame surface.

2. The pipe cutting apparatus of claim 1, wherein the hand guard comprises:
i. a body, the body including:
A. a top surface having a curved shape,
B. a bottom surface having a curved shape and disposed adjacent to the circumferential frame surface, wherein the top surface and the bottom surface form an extended end having a wedge shape,
C. an engagement surface having a concave shape and disposed adjacent to the outer housing surface, and
D. an attachment portion that attaches the hand guard to circumferential frame surface of the frame; and
ii. a first recess formed by the engagement surface and configured to fit on the housing, wherein the first recess is disposed between the attachment leg and the extended end.

3. The pipe cutting apparatus of claim 2, wherein the hand guard is reversibly mounted on the circumferential frame surface.

4. The pipe cutting apparatus of claim 2, wherein the attachment portion is an attachment plate that is reversibly mounted on the circumferential frame surface of the frame.

5. The pipe cutting apparatus of claim 2, wherein the housing has a center and an axis radially passing through the center to divide the housing and the hand guard into a first side and a second side, wherein the extended end of the hand guard is on the first side, and wherein the attachment portion is an attachment leg that abuts the circumferential frame surface on the second side.

6. A hand guard configured to be coupled to a pipe cutting apparatus having a circumferential frame and surface housing, the hand guard comprising:
a) a body, the body including:
i. a top surface having a curved shape,
ii. a bottom surface having a curved shape, wherein the top surface and the bottom surface form an extended end having a wedge shape,
iii. an engagement surface having a curved shape and extending from the bottom surface, and
iv. an attachment portion, and
b) a first recess having a curved shape, wherein the first recess is disposed between the attachment portion and the extended end.

7. The pipe cutting apparatus of claim 6, wherein the attachment portion is an attachment plate that is reversibly mounted on the circumferential frame surface of the frame.

8. The pipe cutting apparatus of claim 6, wherein the surface housing has a center and an axis radially passing through the center to divide the surface housing and the hand guard into a first side and a second side, wherein the extended end of the hand guard is on the first side, and wherein the attachment portion is an attachment leg that abuts the circumferential frame surface on the second side.
